(19) United States
(12) Patent Application Publication
(10) Pub. No.: US 2016/0150063 A1
(43) Pub. Date: May 26, 2016

(54) METHOD OF SHARING CONTENTS AND ELECTRONIC DEVICE THEREOF

(71) Applicant: Samsung Electronics Co., Ltd., Gyeonggi-do (KR)

(72) Inventors: Chi-Won CHOI, Gyeonggi-do (KR); Jae-Hyung PARK, Gyeonggi-do (KR); Jun-Beom PARK, Gyeonggi-do (KR)

(21) Appl. No.: 14/935,558

(22) Filed: Nov. 9, 2015

(30) Foreign Application Priority Data
Nov. 20, 2014 (KR) 10-2014-0162714

(51) Int. Cl. H04M 1/2745; H04M 1/725; H04W 8/00; G06F 3/0484; G06F 3/0482

(52) U.S. Cl. CPC H04M 1/274516; G06F 3/04842; G06F 3/0482; H04W 8/005; H04M 1/72522

(57) ABSTRACT

An electronic device and method for improved sharing of contents. A user selection of contents to be shared with another electronic device is detected. A list of contacts which can share the selected contents is displayed. A user selection of one or more of the displayed contacts is detected. The electronic device displays information at least one application or service, corresponding to the selected one or more contacts, through which the selected contents can be shared.

### CLAIM OF PRIORITY

This application claims priority under 35 U.S.C. §119(a) to Korean Application Serial No. 10-2014-0162714, which was filed in the Korean Intellectual Property Office on Nov. 20, 2014, the entire content of which is hereby incorporated by reference.

### TECHNICAL FIELD

The present disclosure relates to an electronic device and a method for sharing contents.

### BACKGROUND

With recent advances in semiconductor and communication technologies, a electronic device can store various contents and share the contents with one or more other electronic devices. For example, an electronic device can share various contents stored in its local memory with one or more other electronic devices connected through wired resources or radio resources.

### SUMMARY

When an electronic device transmits stored contents to another electronic device, a user of the transmitting electronic device should select an application by which the corresponding contents are transmitted. For example, when a prior art transmitting electronic device includes a plurality of applications, any of which can be used for sharing contents, the user is required to search for each of the plurality of applications to select an application for sharing the contents. As a result, the contents sharing may be delayed. The user may not easily search for the application for sharing the contents due to various conditions such as a place for sharing the contents, time, charging policy, proximity from a target to be shared, and user preference.

Various embodiments described herein may provide an apparatus and a method in which an electronic device easily shares contents with another electronic device.

In accordance with an aspect of the present disclosure, a method of operating an electronic device is provided. A user selection of contents to be shared with another electronic device is detected. A list of contacts which can share the selected contents is displayed. A user selection of one or more of the displayed contacts is detected. The electronic device displays information of at least one application or service, corresponding to the selected one or more contacts, through which the selected contents can be shared. The user may then rapidly select an application or service to handle the sharing, or the electronic device may automatically perform the selection.

In accordance with another aspect of the present disclosure, an electronic device is provided. The electronic device includes an input/output (I/O) interface; a communication module configured to transmit/receive contents to/from one or more other electronic devices associated with respective contacts; a display; and a processor. The processor is configured to: detect a user selection via the I/O interface of one or more contents; control the display to display contacts which can share the selected contents via other electronic devices; detect a user selection via the I/O interface of one or more of the displayed contacts; and control the display to display information of at least one application or service, corresponding to the selected one or more contacts, through which the selected contents can be shared.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an electronic device according to various embodiments;

FIG. 2 is a block diagram of a program module according to various embodiments;

FIG. 3 is a block diagram of an electronic device according to various embodiments;

FIG. 4A, FIG. 4B, FIG. 4C and FIG. 4D each illustrate a screen configuration for sharing contents according to various embodiments;

FIG. 5A, FIG. 5B, FIG. 5C and FIG. 5D each illustrate a screen configuration for sharing contents according to various embodiments;

FIG. 6A, FIG. 6B, FIG. 6C and FIG. 6D each illustrate a screen configuration for sharing contents according to various embodiments;

FIG. 7A and FIG. 7B each illustrate a configuration for sharing contents based on a distance from another electronic device according to various embodiments;

FIG. 8 is a flowchart illustrating a process in which an electronic device performs a content sharing function according to various embodiments;

FIG. 9 is a flowchart illustrating a process in which an electronic device shares contents according to various embodiments; and

FIG. 10 is a flowchart illustrating a process in which an electronic device displays a contact list according to various embodiments.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or programming module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device including a communication function. For example, the electronic device according to various embodiments of the present disclosure may include at least one of: a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart mirror, or a smart watch).

In other embodiments, an electronic device may be a smart home appliance including a communication function. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console (e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like)

In certain embodiments, an electronic device may include at least one of: a piece of furniture or a building/structure; an electronic board; an electronic signature receiving device; a projector; and various measuring instruments (e.g., a water meter, an electricity meter, a gas meter, or a wave meter), each of which includes a communication function.

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

Hereinafter, various embodiments of the present disclosure will describe a technology for sharing contents by an electronic device (interchangeably, just “device”).

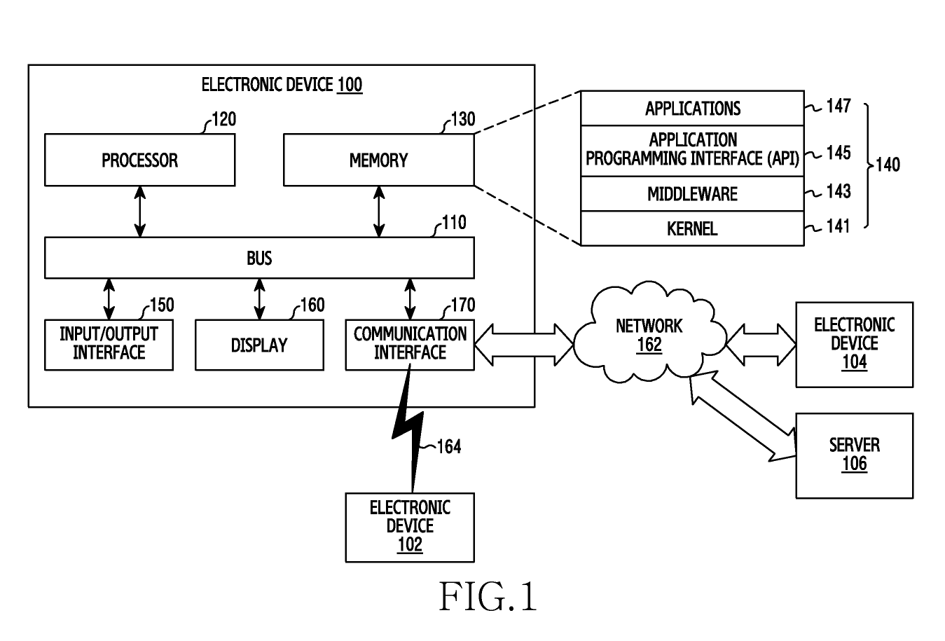

FIG. 1 is a block diagram of an electronic device, 100, according to various embodiments. The electronic device 100 may include a bus 110, a processor 120, a memory 130, an input/output (I/O) interface 150, a display 160, and a communication interface 170. In some embodiments, at least one of the components of the electronic device 100 may be omitted, or other components may be additionally included in the electronic device 100.

The bus 110 may be a circuit that connects the processor 120, the memory 130, the I/O interface 150, the display 160, or the communication interface 170 and transmits communication (for example, control messages) between the above described components.

The processor 120 may include one or more of a Central Processing Unit (CPU), an Application Processor (AP), and a Communication Processor (CP). For example, the processor 120 may carry out operations or data processing related to control and/or communication of at least one other component of the electronic device 100.

Processor 120 may determine an application or service for sharing one or more contents based on input information detected through the input/output interface 150. For example, when the processor 120 detects input information corresponding to execution of a content sharing function through the I/O interface 150, the processor 120 may control the display 160 to display a contact list to share the one or more contents. When the processor 120 detects an input for selecting one or more contacts to share the contents from the contact list through the I/O interface 150, the processor 120 may control the display 160 to display a service list corresponding to the one or more contacts. When the processor 120 detects an input for selecting an application to share the contents from the service list through the I/O interface 150, the processor 120 may make a control to transmit one or more contents to one or more contacts by using the selected application. For example, the contact list may include identification information of one or more other electronic devices supporting the content sharing function. The service list may include application information or service information for sharing contents.

According to an embodiment, the processor 120 may generate or update the contact list. For example, the processor 120 may generate or update the contact list by searching for one or more other electronic devices supporting the content sharing function through the communication interface 170. For example, the processor 120 may generate or update the contact list by searching for one or more other electronic devices having the activated (enabled) content sharing function through the communication interface 170. For example, the processor 120 may periodically update the contact list. For example, the processor 120 may update the contact list when an update event is made (for example, when an input for executing the contact sharing function is detected).

The memory 130 may include a volatile memory and/or a non-volatile memory.

The memory 130 may store, for example, commands or data related to one or more other components of the electronic device 100. According to an embodiment, the memory 130 may store software and/or a program 140. For example, the program 140 may include a kernel 141, middleware 143, an Application Programming Interface (API) 145, and/or application programs 147. At least some of the kernel 141, the middle 143, and the API 145 may be referred to as an Operating System (OS).

The kernel 141 may control or manage system resources (for example, the bus 110, the processor 120, or the memory 130) used for executing an operation or function implemented by other programs (for example, the middleware 143, the API 145, or the applications 147). The kernel 141 may provide an interface through which the middleware 143, the API 145, or the applications 147 may access individual components of the electronic device 100 to control or manage system resources.

The middleware 143 may serve as a relay so that the API 145 or the applications 147 communicates to exchange data with the kernel 141. The middleware 143 may control task requests received from the application programs 147. For example, the middleware 143 may control (for example, schedule or load-balance) task requests by using a method of assigning priorities, by which the system resources of the electronic device 100 can be first used, to at least one of the application programs 147.

The API 145 is an interface by which the applications 147 control functions provided from the kernel 141 or the middleware 143, and may include a function (for example, command). For example, the API 145 may include at least one interface for file control, window control, image processing, or text control

I/O interface 150 may serve as an interface that may transfer commands or data input from a user or another external device to other component (s) of the electronic device 100. Further, the I/O interface 150 may output commands or data received from other component(s) of the electronic device 100 to the user or another external device. I/O interface 150 may include a touchscreen (which may be considered a part of display 160).

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (for example, text, images, videos, icons, or symbols) for users. The display 160 may include a touch screen, and may receive, for example, a touch, gesture, proximity, or hovering input by using an electronic pen or a part of the user's body.

According to an embodiment, the display 160 may display a contact list based on a priority of each of the contacts included in the contact list. For example, the priority of the contacts may be determined based on at least one of a transmission history, a transmission frequency, a transmission speed, a charging policy, preset user favorites (intimacy), a counterpart's location, a schedule, or application preference.

According to an embodiment, the display 160 may display a service list based on a priority of each of the applications or services included in the service list. For example, the priority of the applications or services may be determined based on configuration information of a service provider, configuration information of a manufacturer, contact information, application preference, user preference, a use time point, a distance from a target to share contents, a transmission history, and a charging policy.

The communication interface 170 may connect communication between the electronic device 100 and an external device (for example, the electronic device 104 or the server 106). For example, the communication interface 170 may be connected to a network 162 through wireless communication or wired communication, and may communicate with an external device.

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM) as a cellular communication protocol.

The wireless communication may include at least one of, for example, WiFi, Bluetooth, BLE, Zigbee, Infrared (IR) communication, and ultrasonic communication as a short-range communication protocol 164.

The wired communication may include, for example, at least one of universal serial bus (USB), high definition multimedia interface (HDMI), recommended standard 232 (RS-232), and plain old telephone service (POTS).

The network 162 may include at least one of communication networks such as a computer network (for example, a LAN or a WAN), the Internet, and a telephone network.

The electronic devices 102 and 104 may be devices of the same or different type as the electronic device 100. Server 106 may include a group of one or more servers. All or some of the operations executed in the electronic device 100 may be carried out in another electronic device or a plurality of electronic devices (e.g., 102, 104 or 106). When the electronic device 100 should perform some functions or services automatically or by a request, it may make a request for performing at least some functions related to the functions or services to a second electronic device (e.g., 102, 104, or 106) instead of performing the functions or services by itself or additionally. The second electronic device may carry out the functions requested by the electronic device 100 or additional functions and provide results thereof to the electronic device 100. The electronic device 100 may provide the requested functions or services to a second electronic device based on the received results or after additionally processing the received results. To this end, for example, cloud computing, distributed computing, or client-server computing technology may be used.

According to various embodiments, the electronic device 100 may share one or more contents with one or more other electronic devices by using one or more modules functionally or physically separated from the processor 120.

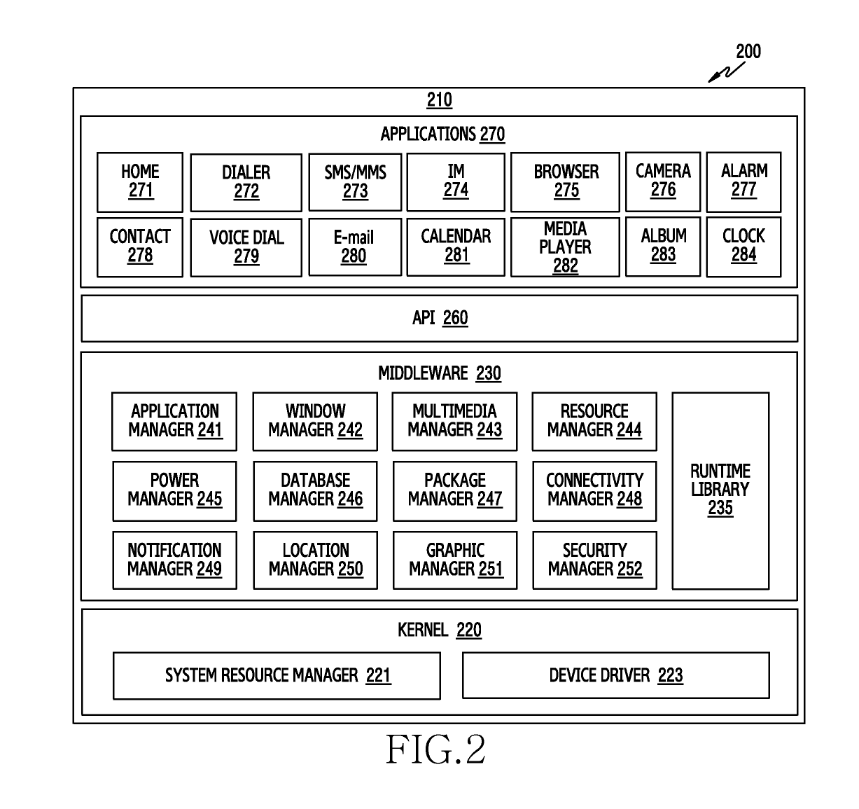

FIG. 2 is a block diagram 200 of a program module 210 according to various embodiments of the present disclosure. Program module 210 (for example, the programs 140) may include an Operating System (OS) for controlling resources related to the electronic device (for example, the electronic device 100) and/or various applications (for example, the application programs 147) executed in the operating system. The operating system may be, for example, Android, iOS, Windows, Symbian, Tizen, Bada, or the like.

The programming module 210 may include a kernel 220, middleware 230, an API 260, and/or applications 270. At least some of the program module 210 may be preloaded in the electronic device or downloaded from the server.

The kernel 220 (for example, the kernel 141 of FIG. 1) may include, for example, a system resource manager 221 or a device driver 223. The system resource manager 221 may control, allocate, or collect the system resources. According to an embodiment, the system resource manager 221 may include a process management unit, a memory management unit, or a file system management unit. The device driver 223 may include, for example, a display driver, a camera driver, a Bluetooth driver, a shared-memory driver, a USB driver, a keypad driver, a WiFi driver, an audio driver, or an Inter-Process Communication (IPC) driver.

The middleware 230 may provide a function required by the applications 270 in common or provide various functions to the applications 270 through the API 260 so that the applications 270 can efficiently use limited system resources within the electronic device. According to an embodiment, the middleware 230 (for example, the middleware 143) may include, for example, at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252.

The runtime library 235 may include, for example, a library module that a compiler uses to add new functions through a programming language while the application 270 is executed. The runtime library 235 may perform I/O management, memory management, or a function for an arithmetic function.

The application manager 241 may manage, for example, a life cycle of at least one of the applications 270. The window manager 242 may manage Graphical User Interface (GUI) resources used by a screen. The multimedia manager 243 may grasp formats required for the reproduction of various media files, and may perform an encoding or decoding of the media file by using a codec suitable for the corresponding format. The resource manager 244 may manage resources such as a source code, a memory, and a storage space of at least one of the applications 270.

The power manager 245 may operate together with a Basic Input/Output System (BIOS) to manage a battery or power and may provide power information required for the operation of the electronic device. The database manager 246 may generate, search for, or change a database to be used by at least one of the applications 270. The package manager 247 may manage the installation or the updating of applications distributed in the form of package file.

The connectivity manager 248 may manage wireless connection of, for example, Wi-Fi or Bluetooth. The notification manager 249 can display or notify of an event such as an arrival message, promise, proximity notification, and the like in such a way that does not disturb a user. The location manager 250 may manage location information of the electronic device. The graphic manager 251 may manage graphic effects to be provided to a user and user interfaces related to the graphic effects. The security manager 252 may provide all security functions required for system security or user authentication. According to an embodiment, when electronic device 100 has a call function, the middleware 230 may further include a telephony manager for managing a voice call function or a video call function of the electronic device.

The middleware 230 may include a middleware module for forming a combination of various functions of the aforementioned components. The middleware 230 may provide modules specialized according to types of operating systems in order to provide differentiated functions. Further, the middleware 230 may dynamically remove some of the existing components or add new components.

The API 260 (for example, the API 145) is, for example, a set of API programming functions, and a different configuration thereof may be provided according to an operating system. For example, Android or iOS may provide one API set per platform, and Tizen may provide two or more API sets per platform.

The applications 270 (for example, the application programs 147) may include, for example, one or more applications which can provide functions such as home 271, dialer 272, SMS/MMS 273, Instant Message (IM) 274, browser 275, camera 276, alarm 277, contacts 278, voice dialer 279, email 280, calendar 281, media player 282, album 283, clock 284, health care (for example, measure exercise quantity or blood sugar), or environment information (for example, atmospheric pressure, humidity, or temperature information).

Applications 270 may include an application (hereinafter, referred to as an “information exchange application” for convenience of the description) supporting information exchange between the electronic device 100 and an external electronic device. The information exchange application may include, for example, a notification relay application for transferring predetermined information to an external electronic device or a device management application for managing an external electronic device.

For example, the notification relay application may include a function of transferring, to the external electronic device, notification information generated from other applications of the electronic device 100 (for example, an SMS/MMS application, an e-mail application, a health management application, or an environmental information application). Further, the notification relay application may receive notification information from, for example, a control device and provide the received notification information to the user. The device management application may manage (for example, install, delete, or update), for example, a function for at least a part of the external electronic device communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

Applications 270 may include an application (for example, health management application) designated according to attributes of the external electronic device (for example, attributes of the electronic device such as the type of electronic device which corresponds to a mobile medical device). According to an embodiment, the applications 270 may include an application received from the external electronic devices (e.g., 104 or server 106). Applications 270 may include a preloaded application or a third party application which can be downloaded from the server. The names of the components of the program module 210 according to the embodiment illustrated in FIG. 2 may vary according to the type of operating system.

According to various embodiments, at least some of the programming module 210 may be implemented by software, firmware, hardware, or a combination of two or more thereof. At least some of the programming module 210 may be implemented (for example, executed) by, for example, the processor (for example, the application program). At least some of the programming module 210 may include, for example, a module, program, routine, sets of instructions, or process for performing one or more functions.

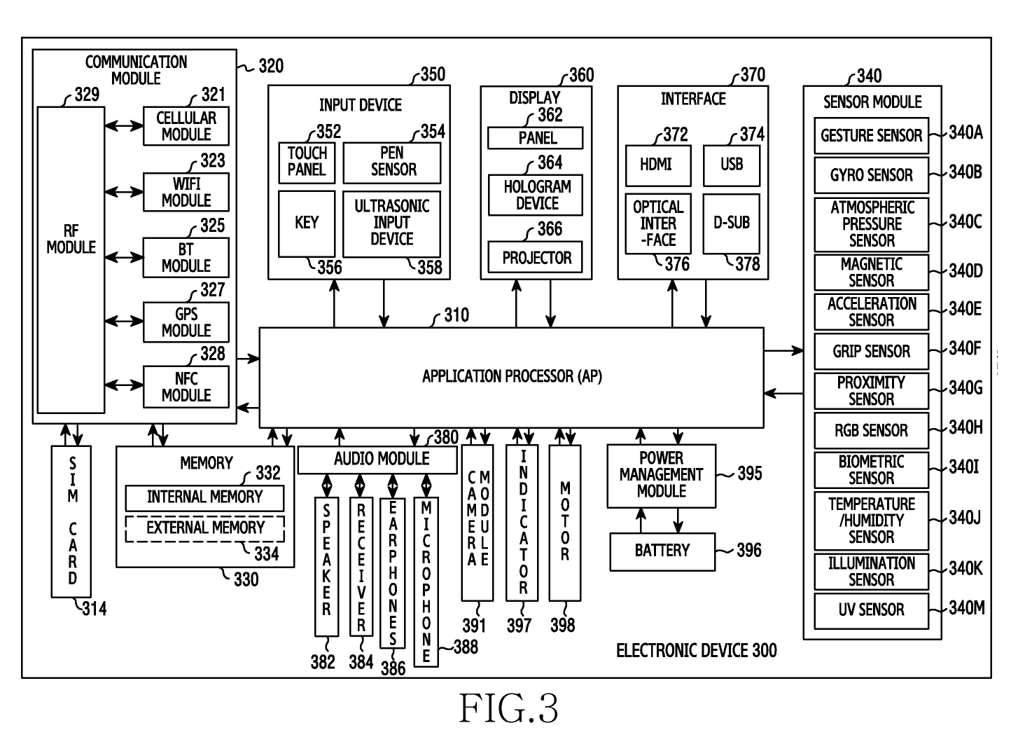

FIG. 3 is a block diagram of an electronic device, 300, according to various embodiments. In the following description, the electronic device 300 is an example of electronic device 100 of FIG. 1. Electronic device 300 may include at least one Application Processor (AP) 310, a communication module 320, a Subscriber Identifier Module (SIM) card 324, a memory 330, a sensor module 340, an input device 350, a display 360, an interface 370, an audio module 380, an camera module (for example, image sensor module) 391, a power management module 395, a battery 396, an indicator 397, and a motor 398.

The AP 310 may drive an operating system or an application program so as to control a plurality of hardware or software components connected to the AP 310, and may execute data processing and operations associated with various data including multimedia data. The AP 310 may be implemented by, for example, a System on Chip (SoC). According to an embodiment, the AP 310 may further include a graphic processing unit (GPU) (not illustrated).

The communication module 320 (for example, the communication interface 170) may perform data transmission/reception in communication between the electronic device 300 (for example, the electronic device 100) and other electronic devices (for example, the electronic devices 102 and 104) connected thereto through the network. According to an embodiment, the communication module 320 may include a cellular module 321, a WiFi module 323, a BT module 325, a GPS module 327, an NFC module 328, and a Radio Frequency (RF) module 329.

The cellular module 321 may provide a voice call, a video call, a short message service (SMS), or an Internet service through a communication network (for example, LTE, LTE-A, CDMA, WCDMA, UMTS, WiBro, or GSM). Further, the cellular module 321 may distinguish between and authenticate electronic devices in a communication network using, for example, a subscriber identification module (for example, the SIM card 324). According to an embodiment, the cellular module 321 may perform at least some of the functions that the AP 310 may provide. For example, the cellular module 321 may perform at least some of the multimedia control functions.

Cellular module 321 may include a communication processor (CP). Further, the cellular module 321 may be implemented by, for example, an SoC. Although the components such as the cellular module 321 (for example, the communication processor), the memory 330, or the power management module 395 are illustrated as components separated from the AP 310, the AP 310 may include at least some of the above described components (for example, the cellular module 321).

The AP 310 or the cellular module 321 (for example, the communication processor) may load a command or data received from at least one of a non-volatile memory and other components connected thereto to a volatile memory and process the loaded command or data. Further, the AP 310 or the cellular module 321 may store data received from or generated by at least one of other components in a non-volatile memory.

For example, each of the WiFi module 323, the BT module 325, the GPS module 327, and the NFC module 328 may include a processor for processing data transmitted/received through the corresponding module. Although each of the cellular module 321, the WiFi module 323, the BT module 325, the GPS module 327, and the NFC module 328 is shown as a separate block in FIG. 3, at least some (for example, two or more) of the cellular module 321, the WiFi module 323, the BT module 325, the GPS module 327, and the NFC module 328 may be included in one integrated chip (IC) or IC package according to an embodiment. For example, at least some (for example, the communication processor corresponding to the cellular module 321 and the WiFi processor corresponding to the WiFi module 323) of processors corresponding to the cellular module 321, the WiFi module 323, the BT module 325, the GPS module 327, and the NFC module 328 may be implemented as one SoC.

The RF module 329 may transmit and receive data, for example, RF signals. Although not illustrated, the RF module 329 may include, for example, a transceiver, a Power Amp Module (PAM), a frequency filter, a Low Noise Amplifier (LNA), or the like. Further, the RF module 329 may further include a component for transmitting and receiving an electromagnetic wave in the free airspace in wireless communication, for example, a conductor or a conductive wire. Although the cellular module 321, the WiFi module 323, the BT module 325, the GPS module 327, and the NFC module 328 are illustrated to share one RF module 329 in FIG. 3, at least one of the cellular module 321, the WiFi module 323, the BT module 325, the GPS module 327, and the NFC module 328 may transmit/receive an RF signal through a separate RF module.

RF module 329 may include at least one of a main antenna and a sub antenna, which is functionally connected to the electronic device 300. The communication module 320 may support a Multiple Input Multiple Output (MIMO) service such as diversity by using the main antenna and the sub antenna.

The SIM card 324 may be a card including a subscriber identification module and may be inserted into a slot formed in a predetermined position of the electronic device. The SIM card 324 may include unique identification information (for example, an integrated circuit card identifier (ICCID)) or unique subscriber information (for example, an international mobile subscriber identity (IMSI)).

The memory 330 may include an internal memory 332 or an external memory 334. The internal memory 332 may, for example, include at least one of a volatile memory (for example, a Dynamic Random Access Memory (DRAM), a Static RAM (SRAM), or a Synchronous Dynamic RAM (SDRAM)) and a non-volatile memory (for example, a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, or a NOR flash memory).

The internal memory 332 may be a Solid State Drive (SSD). The external memory 334 may further include a flash drive, for example, a compact flash (CF), a secure digital (SD), a micro secure digital (Micro-SD), a mini secure digital (Mini-SD), an extreme digital (xD), a Memory Stick, or the like. The external memory 334 may be functionally connected to the electronic device 300 through various interfaces. Electronic device 300 may further include a storage device (or storage medium) such as a hard disc drive.

The sensor module 340 may measure a physical quantity or sense an operational state of the electronic device 300 and may convert the measured or sensed information to an electric signal. The sensor module 340 may include at least one of, for example, a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (for example, a Red/Green/Blue (RGB) sensor), a biometric sensor 340I, a temperature/humidity sensor 340J, an illumination sensor 340K, and an Ultra Violet (UV) sensor 340M. Additionally or alternatively, the sensor module 340 may, for example, include an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), a fingerprint sensor (not shown), and the like. The sensor module 340 may further include a control circuit for controlling one or more sensors included therein.

The input device 350 may include a touch panel 352, a (digital) pen sensor 354, a key 356, or an ultrasonic input device 358. The touch panel 352 may recognize a touch input in at least one of, for example, a capacitive type, a resistive type, an infrared type, and an acoustic wave type. Further, the touch panel 352 may further include a control circuit. In the case of the capacitive type, physical contact or proximity recognition is possible. The touch panel 352 may further include a tactile layer. In this case, the touch panel 352 may provide a user with a tactile reaction.

The (digital) pen sensor 354 may be implemented, for example, using a method identical or similar to a method of receiving a touch input of a user, or using a separate recognition sheet. The key 356 may include, for example, a physical button, an optical key, or a keypad. The ultrasonic input device 358 is a device which can detect an acoustic wave by a microphone through an input means generating an ultrasonic signal to identify data and can perform wireless recognition. According to an embodiment, the electronic device 300 may also receive a user input from an external device (for example, a computer or server) connected thereto using the communication module 320.

The display 360 (an example of display 160) may include a panel 362, a hologram device 364 or a projector 366. The panel 362 may be, for example, a Liquid Crystal Display (LCD), an Active Matrix Organic Light Emitting Diode (AM-OLED), or the like. The panel 362 may be implemented to be, for example, flexible, transparent, or wearable. The panel 362 may be formed to be a single module with the touch panel 352. The hologram device 364 may show a three dimensional image in the air by using an interference of light. The projector 366 may display an image by projecting light onto a screen. The screen may be located, for example, inside or outside the electronic device 300. Display 360 may further include a control circuit for controlling the panel 362, the hologram device 364, or the projector 366.

The interface 370 may include, for example, a High-Definition Multimedia Interface (HDMI) 372, a Universal Serial Bus (USB) 374, an optical interface 376, or a D-subminiature (D-sub) 378. Additionally or alternatively, the interface 370 may, for example, include a mobile high-definition link (MHL) interface, a secure digital (SD) card/multi-media card (MMC) interface, or an infrared data association (IrDA) interface.

The audio module 380 may bidirectionally convert a sound and an electrical signal. The audio module 380 may process sound information which is input or output through, for example, a speaker 382, a receiver 384, earphones 386, the microphone 388 or the like.

The camera module 391 is a device for photographing still and moving images, and may include one or more image sensors (for example, a front sensor or a rear sensor), a lens (not illustrated), an Image Signal Processor (ISP, not illustrated), or a flash (for example, an LED or a xenon lamp, not illustrated) according to an embodiment.

The power management module 395 may manage power of the electronic device 300. Although not illustrated, the power management module 395 may include, for example, a Power Management Integrated Circuit (PMIC), a charger Integrated Circuit (IC), or a battery or fuel gauge.

The PMIC may be mounted within, for example, an integrated circuit or an SoC semiconductor. The charging methods may be classified into wired charging and wireless charging. The charger IC may charge a battery and may prevent an overvoltage or excess current from being induced or flowing from a charger. The charger IC may include a charger IC for at least one of the wired charging and the wireless charging. Examples of the wireless charging may include magnetic resonance charging, magnetic induction charging, and electromagnetic charging, and an additional circuit such as a coil loop, a resonance circuit, a rectifier or the like may be added for the wireless charging.

The battery gauge may measure, for example, a residual quantity of the battery 396, and a voltage, a current, or a temperature during the charging. The battery 396 may store or generate electricity and may supply power to the electronic device 300 by using the stored or generated electricity. The battery 396 may include, for example, a rechargeable battery or a solar battery.

The indicator 397 may display a predetermined state of the electronic device 300 or a part of the electronic device 300 (for example, the AP 310), such as a booting state, a message state, a charging state, or the like. The motor 398 may convert an electrical signal into a mechanical vibration. Although not illustrated, the electronic device 300 may include a processing unit (for example, a GPU) for supporting mobile TV. The processing unit for supporting mobile TV may process, for example, media data pursuant to a certain standard of Digital Multimedia Broadcasting (DMB), Digital Video Broadcasting (DVB), or media flow.

Each of the above described elements of the electronic device according to various embodiments of the present disclosure may be formed of one or more components, and the name of a corresponding element may vary according to the type of an electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

According to various embodiments, an electronic device (e.g., 100, 300) may include: an input/output (I/O) interface; a communication module configured to transmit/receive contents to/from one or more other electronic devices associated with respective contacts; a display; and a processor. The processor may be configured to: detect a user selection via the I/O interface of one or more contents; control the display to display contacts which can share the selected contents via other electronic devices; detect a user selection via the I/O interface of one or more of the displayed contacts; and control the display to display information of at least one application or service, corresponding to the selected one or more contacts, through which the selected contents can be shared.

According to various embodiments, the communication module may search for one or more other electronic devices, which can share the selected contents, in response to the selection of the one or more contents by the processor.

According to various embodiments, the processor may control the display to display the contact information based on at least one of search information on other electronic devices, which can share the selected contents, through the communication module and a preset priority.

According to various embodiments, the priority may be determined based on at least one of a transmission history, a transmission frequency, a transmission speed, a charging policy, preset user favorites, a counterpart's location, a schedule, and application preference.

According to various embodiments, the service information may include one or more pieces of application information based on the selected contact information.

According to various embodiments, the processor may control the display to display the service information based on a priority corresponding to the one or more pieces of selected contact information.

According to various embodiments, the priority may be determined based on at least one of configuration information of a service provider, configuration information of a manufacturer, contact information, application preference, user preference, a use time point, a distance from a target to share content, a transmission history, and a charging policy.

According to various embodiments, the processor may control the display to display the one or more pieces of service information corresponding to the selected contents and the one or more pieces of selected contact information.

According to various embodiments, the electronic device may further include a communication module for transmitting the one or more contents to other electronic devices corresponding to the one or more pieces of selected contact information through one piece of the one or more pieces of service information selected by the processor and displayed on the display.

According to various embodiments, the processor may control an operation of transmitting the one or more contents to one or more other electronic devices located within a predetermined distance.

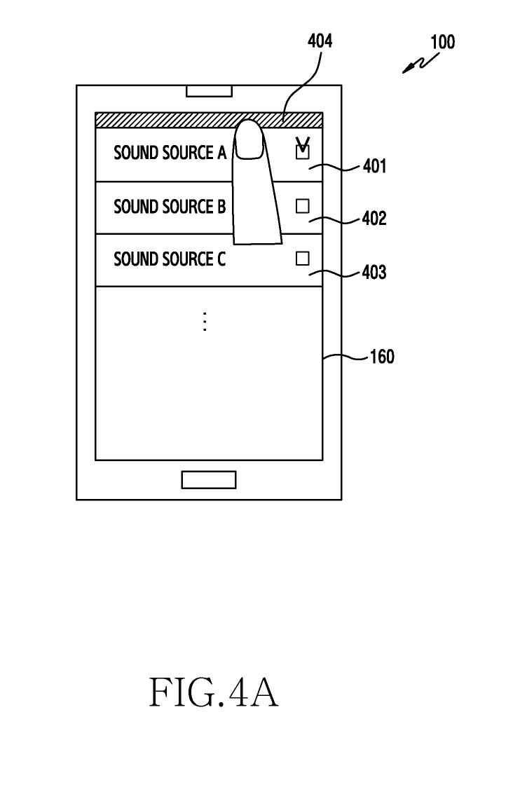

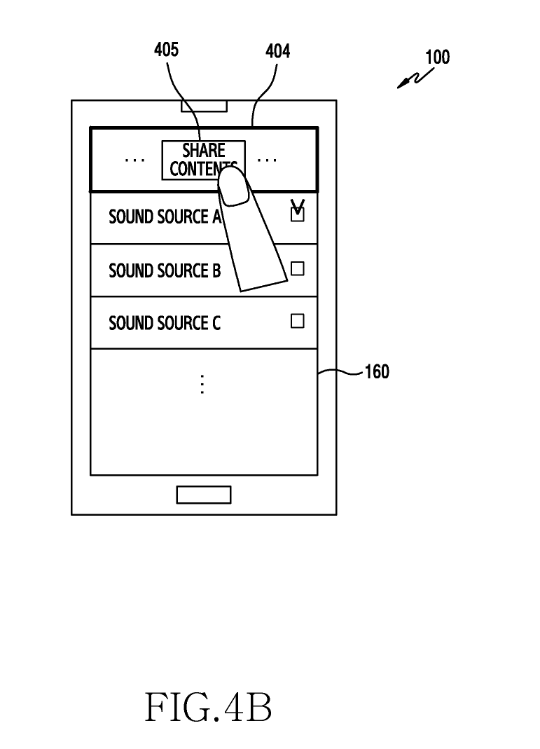

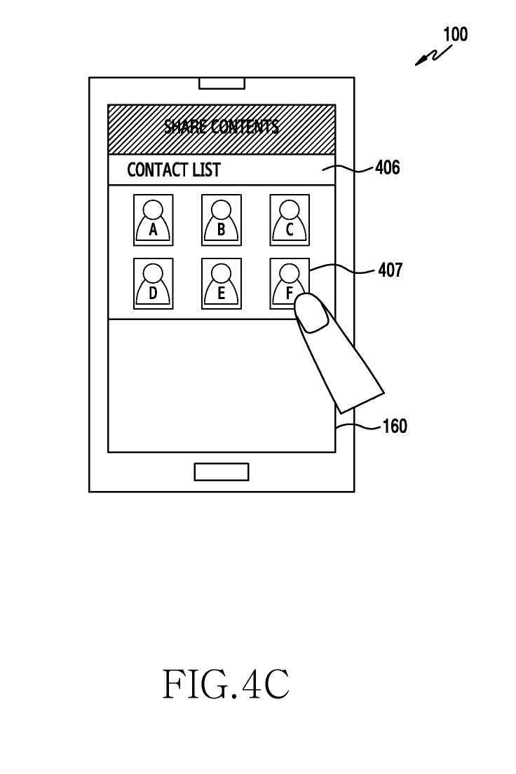

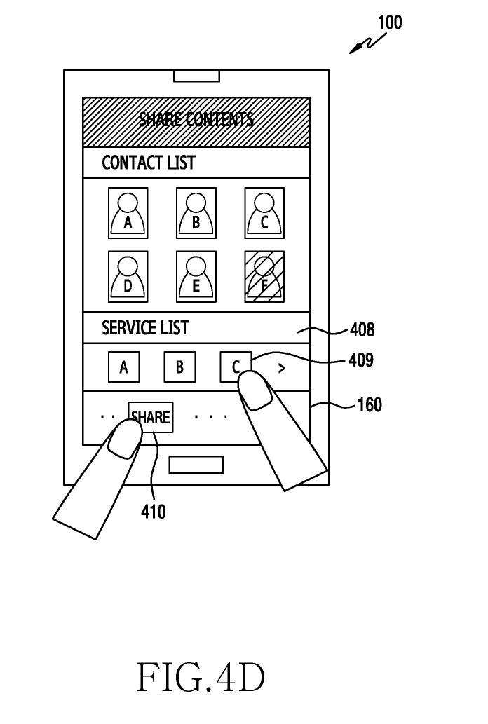

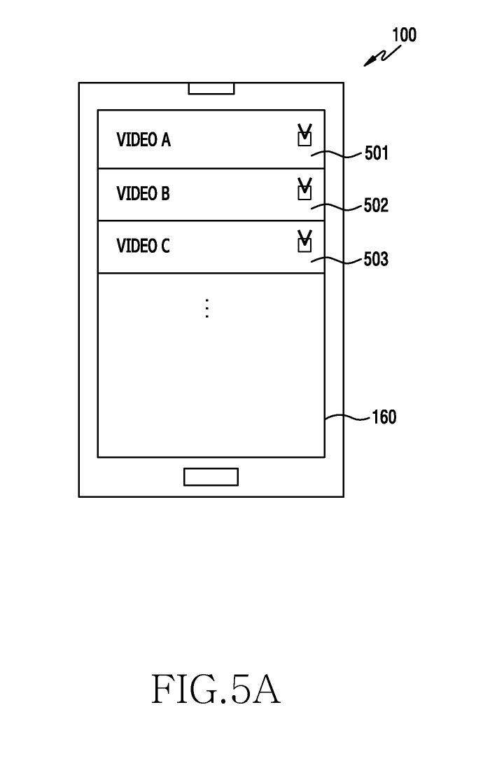

FIGS. 4A to 4D illustrate screen configurations of the electronic device 100 for sharing contents according to various embodiments. The electronic device 100 may share one or more contents stored in memory 130 with one or more other electronic devices. For example, electronic device may select a “sound source A 401” among a plurality of sound sources 401, 402, and 403 stored in the electronic device as a content to be shared with another electronic device based on input information detected through I/O interface 150, as illustrated in FIG. 4A. (Herein, when a electronic device is said to “select” an item of content, an icon, etc., this refers to the electronic device detecting a user input selecting the item, and designating that item as selected for a further operation.)

According to various embodiments, the electronic device 100 may share the “sound source A 401” with one or more other electronic devices by performing a “content sharing” function, i.e., a method of sharing contents with another electronic device, based on input information detected through I/O interface 150.

The content sharing function may include a function for allowing the user to select a target to share an item of content with (hereafter, “target device”), and automatically recommending one or more services or applications which can be used for sharing the content with the selected target. The content sharing function may also provide information on the one or more services or applications to allow the user to easily select the one or more services or applications. According to an embodiment, the electronic device 100 may determine one or more services or applications, which can be used for sharing contents, based on at least one of a priority configured by the user, environment around the electronic device 100 (for example, place, time, distance from the target device, and the like) and accumulated sharing information related to the target device (for example, a recently used service, a frequently used service, a charging policy, and the like).

The electronic device 100 may display a menu (for example, a content sharing icon or button) for sharing contents with another electronic device based on a user input detected through I/O interface 150. For example, when the electronic device 100 detects a touch, hovering, or drag in an indicator area 404 displayed in a part of the screen of FIG. 4A, it may display a content sharing icon 405 as illustrated in FIG. 4B. For example, when the electronic device 100 detects a menu option execution or gesture for displaying a contents sharing menu, the content sharing icon 405 may be displayed in an expanded region of the indicator area 404 while the content items 401, 402, etc. are shifted downwards as illustrated. The electronic device 100 may thereafter detect a user selection of icon 405 via touch input.

When a user selection of the content sharing icon 405 is detected, the electronic device 100 may display a contact list 406 in at least a portion of the display screen as illustrated in FIG. 4C. For example, a contact list 406 may be displayed, which includes contact icons 407 (or other list information) of contacts A through F, where each contact icon 407 is associated a user device that can share one or more contents through the content sharing function. For example, the contact list may include information on one or more other electronic devices, to which the electronic device 100 can transmit one or more contents through the content sharing function. The contact list may include a contact's name, or email address, phone number, etc., which is representative of another electronic device (owned/used by that contact). It is noted, phrases used herein such as “sharing contents with a contact” or “transmitting content to a contact” signifies that contents are shared with a electronic device associated with the contact. Further, phrases such as “displaying contacts” refers to displaying information identifying contacts such as a contact's name or photo. Of course, contents are transmitted to contacts' devices, but a contact may dynamically change a electronic device in current use by inserting a SIM card into a different electronic device on the fly, logging in to an email account at a different computer, etc.

To generate the contact list 406, it may be established beforehand which contacts are capable of receiving the content desired to be shared. In this regard, the electronic device 100 may search for another electronic device, which can execute/support the content sharing function, or another electronic device having an activated content sharing function, when the contact sharing function is initially selected at the electronic device 100. To this end, the electronic device 100 may transmit a request signal to one or more other electronic devices having a deactivated content sharing function, to request activation of the function at the other electronic device(s). For example, the electronic device 100 may transmit a request signal that requests activation of the content sharing function, to another electronic device located within a predetermined range by using a short-range communication scheme such as a Bluetooth Low Energy (BLE) technique.

The electronic device 100 may display an updated contact list 406 based on search information on other electronic devices, which can share one or more contents, and/or a preset priority. For instance, the electronic device 100 may determine the priority of a contact based on at least one of a transmission history, a transmission frequency, a transmission speed, an application preference, and a charging policy.

According to an embodiment, when a priority of at least one contact included in the contact list is updated by a request from the user or another electronic device, the electronic device 100 may update the contact list based on the updated priority and display the updated contact list. (If the contact list 406 is initially displayed, it may be changed “on the fly” to an updated contact list 406 as soon as an updated priority is determined.) For example, when the electronic device 100 performed the contact sharing function with a electronic device of contact A most recently and performed the contact sharing function with a electronic device of contact F least recently among contacts A to F included in the contact list, the contact list may be displayed in the order from A through F based on the priority determined in accordance with the transmission history. According to an embodiment, when the number of contacts included in the contact list 406 is large, the contact list 406 may be displayed via distribution over a plurality of pages. In this case, a user of the electronic device 100 may search for a contact to be shared, through scrolling.

When a user selects a contact from the contact list 406 to share content with as shown in FIG. 4C, the screen may transition to a content sharing screen as depicted in FIG. 4D, which may include a “Service List” 408 in a preset region, with selectable icons 409. Each icon 409 may represent an application or service that may be used to share one or more contents with one or more other electronic devices.

In an example, the electronic device 100 may display a service list 408 including one or more applications, which can be used for sharing contents with the electronic device of the selected contact F as illustrated in FIG. 4D (contact F may be displayed emphasized in any suitable manner to indicate it is currently selected). The electronic device 100 may display the service list 408 updated based on a preset priority on the display. The service list may be updated according to a preset priority based on at least one of configuration information of a service provider, configuration information of a manufacturer, contact list information, application preference, user preference, a use time point, a distance from a target to share contents, a recently used application, and a charging policy According to an embodiment, when the electronic device 100 configures the priority based on a transmission speed (data transmission rate) at which the electronic device can transmit one or more contents to another electronic device, the electronic device 100 may display the service list updated according to an order of a fast transmission speed.

Alternatively, the electronic device 100 may configure the priority based on the use frequency of the service, and may display the service list updated according to an order of a high use frequency (with the service/application used most frequently displayed in the highest position on the list). For example, the use frequency of the service list may be configured for each contact selected to share contents or configured based on a service used most frequently by electronic device 100.

The electronic device 100 may receive a user selection for an application/service 409 to be used for sharing contents, and initiate contents sharing using the selected application/service. For example, a user may select an “application C 409” from the applications included in the service list 408 as illustrated in FIG. 4D. The electronic device 100 may respond to the selection by transmitting the contents selected to be shared based on a sharing command detected through the I/O interface 150. For example, the electronic device 100 may transmit the “sound source A 401” to the electronic device of contact F 407 by using the “application C 409” in response to selection of a “sharing icon 410” as illustrated in FIG. 4D.

If the user selects two or more icons 409 and then touches the share icon 410, the contents to be shared may be transmitted to contact F using multiple services/applications corresponding to the selected icons 409.

According to an embodiment, the electronic device 100 may manage the service list according to each contact list. For example, the electronic device 100 may display the service list 408 differently when contact A is selected as compared to when contact F is selected. That is, the electronic device 100 may dynamically configure the service list in accordance with the target (contact) to which the contents are to be transmitted.

According to an embodiment, when the electronic device 100 detects user selection of the sharing icon 410 in a state where a particular application is not selected from the service list 408, the electronic device 100 may share contents by using an application having a highest priority in the service list.

According to an embodiment, when the electronic device 100 selects a particular contact or a particular application based on input information detected through the input/output interface, the electronic device may 100 share contents by using the corresponding contact or the corresponding application.

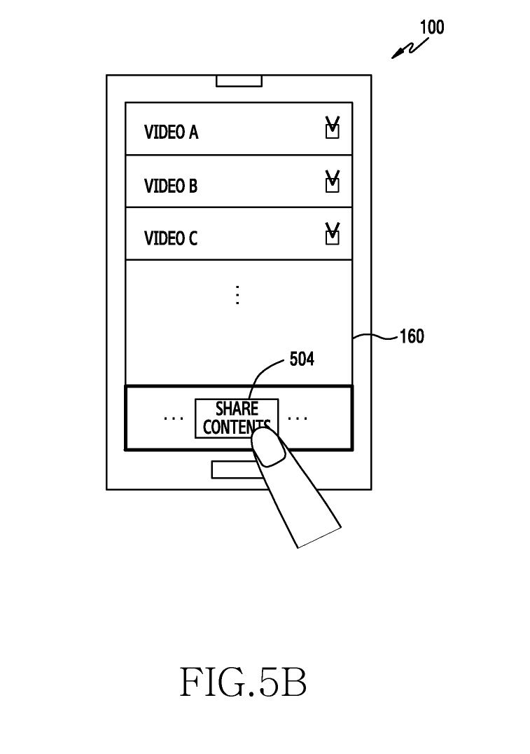

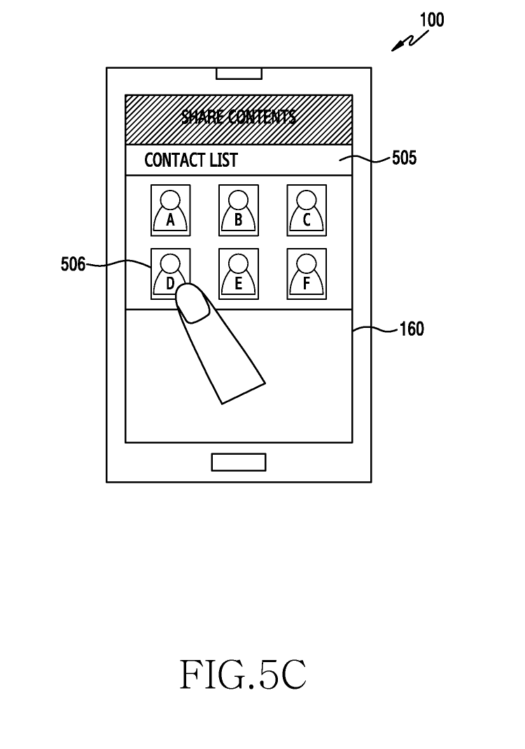

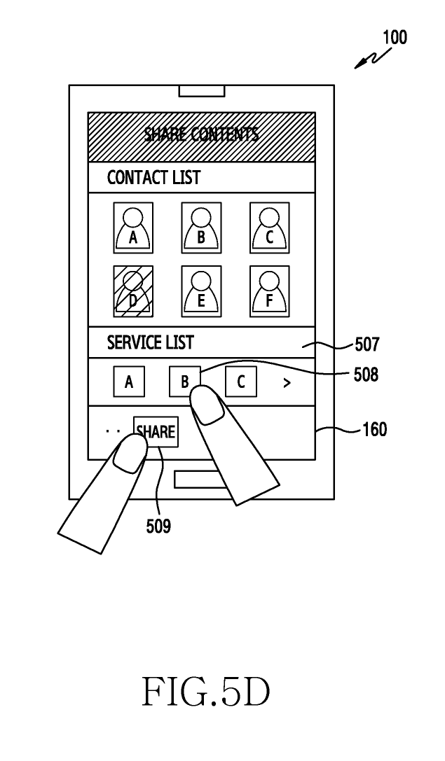

FIGS. 5A to 5D illustrate screen configurations for sharing multiple contents according to various embodiments. Referring to FIG. 5A, the electronic device 100 may select one or more contents to be shared with one or more other electronic devices based on user inputs detected through the I/O interface 150. The contents to be shared may be contents stored in the electronic device 100 memory 130. For example, the electronic device 100 may select “a video A 501, a video B 502, and a video C 503” among a plurality of videos 501, 502, and 503 stored in memory 130 as contents to be shared with another electronic device, as illustrated in FIG. 5A.

According to various embodiments, the electronic device may display a menu, e.g., a “content sharing” icon or button 504, for sharing contents in response to selection of the contents to be shared with another electronic device. For instance icon 504 may be displayed in at least some areas of the display in response to selection of one or more contents as illustrated in FIG. 5B.

According to various embodiments, the electronic device 100 may detect selection of the content sharing button 504 based on touch input detected through the I/O interface 150. For example, the electronic device may detect selection of button 504 displayed in a lower area of the display as illustrated in FIG. 5B.

According to an embodiment, the electronic device may display a contact list in at least a portion of the “content sharing” screen displayed on display 160 in response to the selection of the “content sharing” function. The electronic device 100 may search for another electronic device, which can execute/support the content sharing function or another electronic device having an activated “content sharing” function in response to the selection of the content sharing function.

The electronic device 100 may display the contact list updated based on at least one of search information on other electronic devices, which can share a plurality of contents (for example, the “video A 501, the video B 502, and the video C 503”) and a preset priority. For example, the electronic device may display a contact list 505 including contact A to contact F, representing electronic devices which can share a plurality of contents”, on the display as illustrated in FIG. 5C.

The electronic device 100 may select at least one contact from the contact list displayed on the display based on user inputs detected through the I/O interface 50. For example, the electronic device 100 may select a contact D icon 506 from the contact list as illustrated in FIG. 5C, effectively selecting a electronic device owned/used by contact D as a candidate electronic device to share contents.

The electronic device 100 may display a service list in at least some of the content sharing screen in response to the selection of at least one contact to share one or more contents. For example, a service list 507 may be displayed, corresponding to the contact D 506 as illustrated in FIG. 5D.

The electronic device 100 may select an application to be used for sharing contents from the service list displayed on the display based on user inputs detected through I/O interface 150. For example, the electronic device 100 may select an “application B 508” from the applications included in the service list 507 as illustrated in FIG. 5D.

The electronic device 100 may dynamically change the contact list in accordance with characteristics of the contents selected to be shared with electronic devices used by the contacts, or display transmission applications differently as a function of the contents. For example, suppose the user of the electronic device 100 desires to transmit a picture and a video to a receiving electronic device used by contact D. Also suppose that both a Bluetooth communication and a wireless LAN (e.g. WiFi) communication (examples of different services) are currently available for data exchange between the transmitting and receiving electronic devices. The user may desire to transmit the picture to the receiving electronic device of contact D through a Bluetooth scheme but transmit the video through the wireless LAN., The electronic device 100 may display a service list updated based on any of a number of factors, allowing the user to select a service for each of the selected contents. An updated service list may be based on at least one of the number of contents selected to be shared, capacity, and transmission speed available for each service. Alternatively, the transmitting the electronic device 100 may automatically select an application/service according to the characteristics of each of the contents.

When the electronic device 100 selects at least one application for sharing contents from the service list, it may transmit the contents to be shared based on a sharing command detected through the I/O interface 150 to one or more other electronic devices. For example, the electronic device 100 may transmit “the video A, the video B, and the video C 501 to 503” to the electronic device of contact D by using “the application B 508” in response to selection of a “sharing button 509” as illustrated in FIG. 5D.

According to various embodiments, the electronic device may transmit the contents selected to be shared, to one or more other electronic devices in response to the selection of at least one application for sharing the contents.

According to various embodiments, the electronic device 100 may transmit one or more contents to (the electronic devices of) a plurality of contacts included in the contact list. For example the electronic device 100 may transmit one or more contents to a plurality of contacts by using one application selected from the service list. For example, the electronic device may transmit one or more contents to each of a plurality of contacts by using an application corresponding to each of the contacts selected from the service list. When the electronic device 100 selects the “sharing button 410 or 509” based on user input selection in a state where a particular application is not selected from the service list 408 or 507, the electronic device 100 may transmit the contents to each of the contacts by using an application having a highest priority according to each contact in the service list.

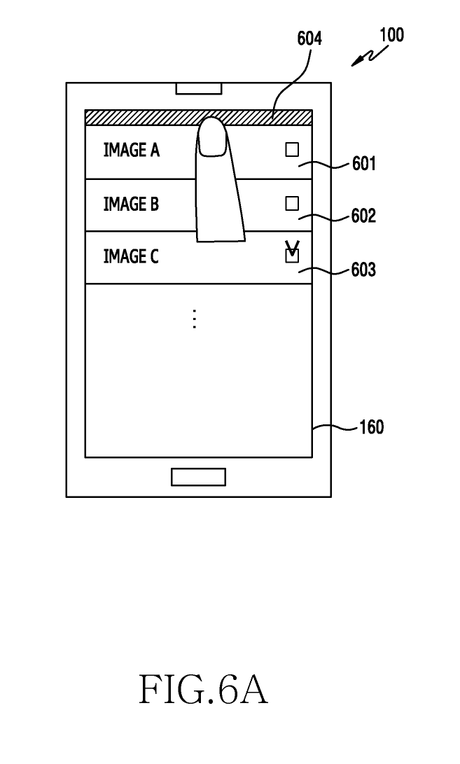

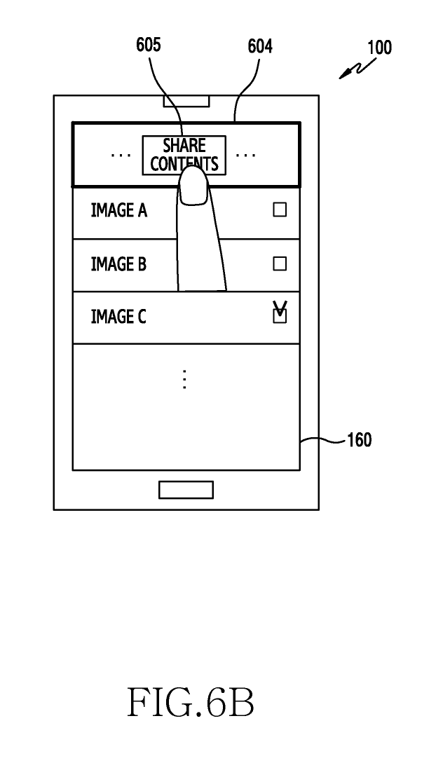

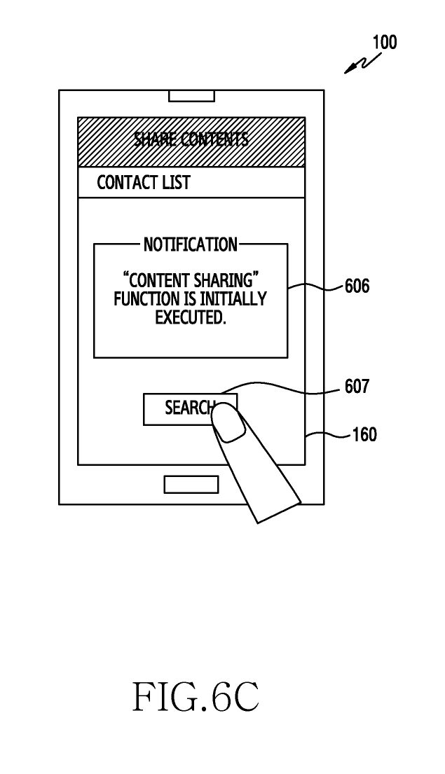

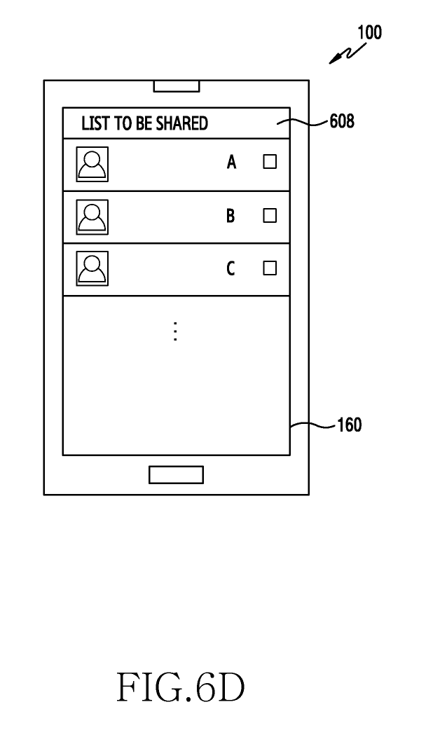

FIGS. 6A to 6D illustrate screen configurations for sharing contents according to various embodiments. These screen examples illustrate a method for initially executing a contents sharing function. As described in embodiments above, the electronic device 100 may select one or more contents to be shared with one or more other electronic devices based on user input selections. For example, one or more contents may be selected from sharing from a plurality of contents stored in memory of the electronic device. For instance, as illustrated in FIG. 6A, the electronic device 100 may receive a user selection for an “image C 603” among a plurality of images 601, 602, and 603 stored in the electronic device 100 as an image to be shared with another electronic device. (A suitable indication, such as a box checked adjacent the selected item, may be used to inform the user of a successful selection.)

According to an embodiment, with a content item already selected to as in FIG. 6A, the electronic device 100 may display a menu (for example, a “content sharing” icon or button) for sharing contents with another electronic device, responsive to a user input. For example, when the electronic device 100 detects a touch or drag in an indicator area 604 as seen in FIG. 6A, this may cause the screen to transition to that seen in FIG. 6B, in which a content sharing icon or button 605 is displayed.

If the electronic device 100 detects a user selection of the content sharing button 605, a content sharing function may be initially executed.

According to various embodiments, when the electronic device 100 initially executes the content sharing function, it may not have data for displaying a contact list. Consequently, as seen in FIG. 6C, the electronic device 100 may display a notification message (for example, “content sharing function is initially executed”) apprising the user of the initial execution of the content sharing function.

The electronic device 100 may then search for another electronic device, which can execute/support the content sharing function or another electronic device having an activated content sharing function, in response to the selection of a “search button 607” displayed on display 160.

Thereafter, the electronic device 100 may generate a contact list based on search information on other electronic devices, which can share one or more contents (for example, “the image C 603” selected as illustrated in FIG. 6A) and display the generated contact list on the display. For example, as illustrated in FIG. 6D, the electronic device 100 may display a contact list 608 including contact A to contact C, which can share contents, based on search information for other electronic devices which can share one or more contents.

According to an alternative embodiment, when the electronic device initially executes the “content sharing” function, the electronic device may search for another electronic device, which can execute the “content sharing” function or has an activated “content sharing” function, simultaneously with or sequentially after the notification message indicating the initial execution of the “content sharing” function is displayed on the display. That is, the electronic device may search for another electronic device, which can execute the “content sharing” function or has the activated “content sharing” function, without any input of selection of the “search button 607”.

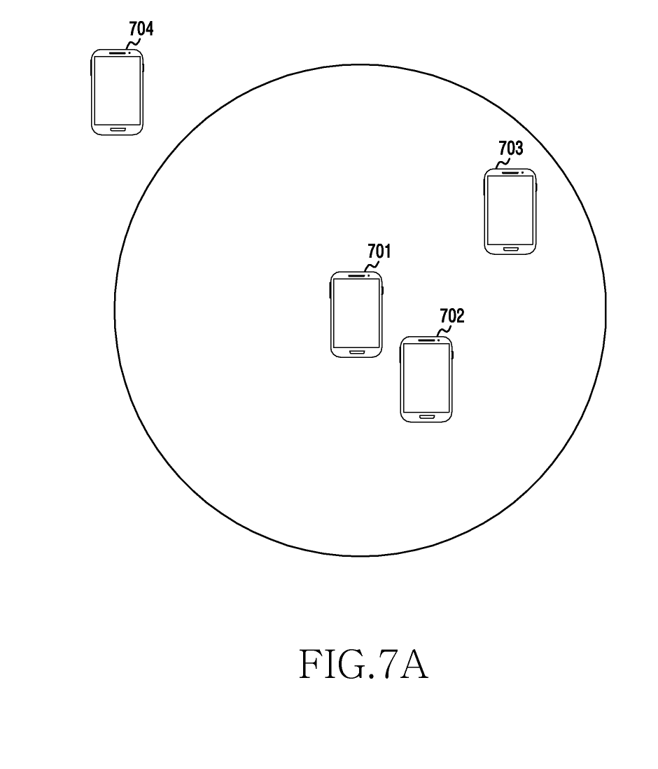

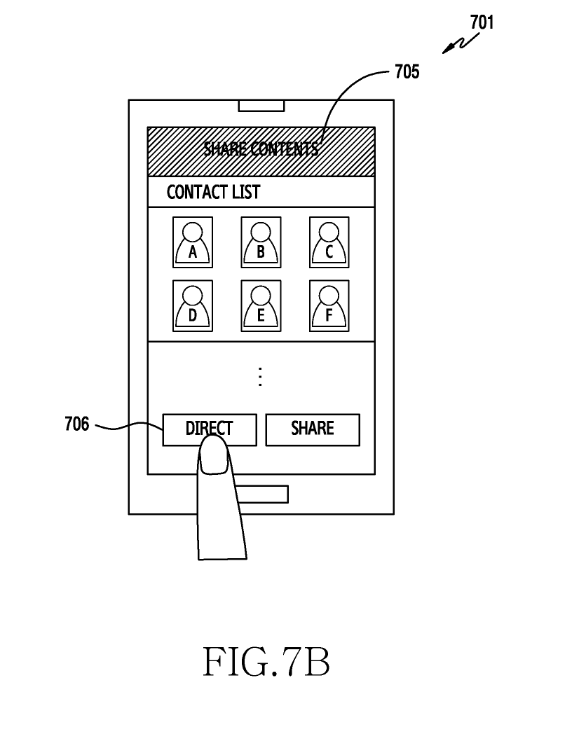

FIGS. 7A and 7B illustrate configurations for sharing contents based on a distance from another electronic device according to various embodiments.

Referring to FIG. 7A, a first electronic device 702, a second electronic device 703, and a third electronic device 704 may be located at points surrounding an electronic device 701, such that electronic device 701 is centrally located with respect to the other electronic devices. For example, the content sharing function of each of the electronic devices 701, 702, 703, and 704 may be activated, and the first electronic device 702 and the second electronic device 703 may be located within a range in which short-range communication with the electronic device 701 is possible. The electronic devices 701-704 may each be an example of the electronic device 100 of FIG. 1.

In an example, a user of electronic device 701 may select one or more contents to be shared with the first electronic device to the third electronic device 702, 703, and 704. The electronic device 701 may then execute the content sharing function by which one or more contents can be shared. For example, when the electronic device executes the “content sharing” function, it display a screen for executing the content sharing function as described in the embodiments above.

According to an embodiment, the electronic device 701 may display a contact list including user images of the first, second and third electronic devices 702, 703, and 704 on the display. For example, the electronic device 701 may mark, on its display, the first electronic device 702 and the second electronic device 703 as electronic devices which can perform short-range communication (for example, wireless LAN, Bluetooth, or NFC) with the electronic device 701, in the contact list.

When electronic device 701 shares contents with external electronic devices using short-range communication, a transmission speed may be maximized and service provider costs for data sharing usage may be minimized, especially for data sharing of large capacity content.

When the electronic device 701 selects a contact of the first electronic device 702 or the second electronic device 703, to which contents included in the contact list displayed on the display can be transmitted through short-range communication, the electronic device 701 may update a priority of an application or service supporting the short-range communication (for example, assign a high priority to the application or service supporting the short-range communication) and display the updated priority in the service list.

According to various embodiments, when executing the “content sharing” function, the electronic device 701 may perform an operation for searching for other electronic devices around the electronic device 701. For example, when the electronic device selects the content sharing function or selects at least one contact in a state where the contact list is displayed, the electronic device may perform an operation for searching for other electronic devices around the electronic device to determine whether short-range communication with the corresponding contact is possible. Electronic devices within short range distance may be discovered using any suitable technique such as Bluetooth device discovery.

As depicted in FIG. 7B, the electronic device may display a screen 705 for sharing contents on the display in response to execution of the content sharing function, e.g., detecting a touch gesture in the top shaded region corresponding to indicator area 404 described earlier.

According to an embodiment, the electronic device may detect a command for executing a “direct” option, responsive to user touch input on a “direct” icon 706 or other suitable command. The electronic device 701 may transmit one or more selected contents to one or more other electronic devices (e.g., 702, 703) located within a preset distance in response to the execution of the direct option. For example, electronic device 701 may share one or more contents through an operation for tagging one or more other electronic devices located within a preset range in which short-range communication with electronic device 701 is possible.

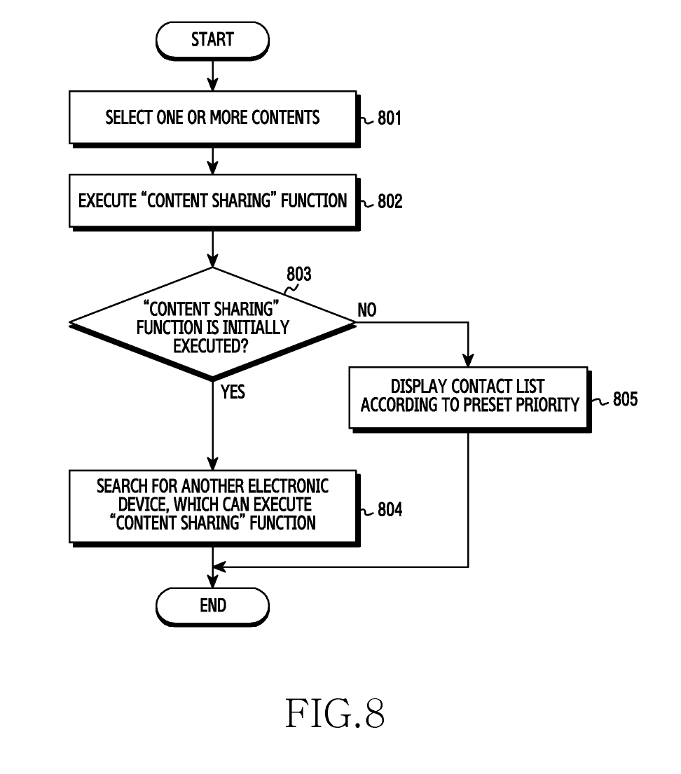

FIG. 8 is a flowchart illustrating a process in which an electronic device performs a content sharing function according to various embodiments. Electronic the electronic device 100 may select one or more contents in operation 801. Here, the electronic device 100 may select one or more contents to be shared with another electronic device from a plurality of contents stored in the electronic device 100.

In operation 802, the electronic device 100 may execute the content sharing function. To this end, the electronic device 100 may detect selection of a “content sharing” icon displayed in a preset area of display 160.

In operation 803, it is determined whether the content sharing function is initially executed. This may occur when the content sharing icon is initially selected.

In operation 804, when the electronic device determines that the content sharing function is initially executed, it may search for another electronic device which can execute the content sharing function or another electronic device having an activated content sharing function. In this regard, the electronic device may transmit a request signal to another electronic device having a deactivated content sharing function to request activation of the function. For instance, the request signal be transmitted to another electronic device located within a predetermined range by using a short-range communication scheme such as a Bluetooth Low Energy (BLE) technique.

When the content sharing function is not initially executed, the electronic device may display a contact list on the display according to a preset priority in operation 805.

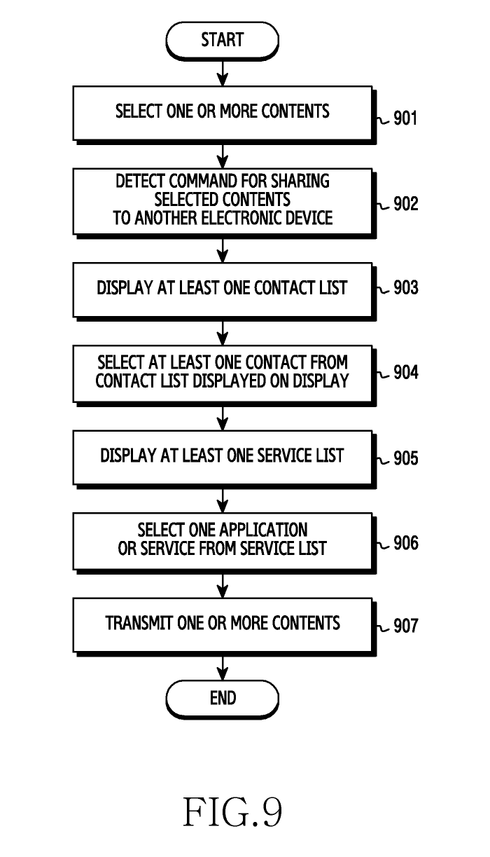

FIG. 9 is a flowchart illustrating a process in which an electronic device shares contents according to various embodiments. The electronic device 100 may select one or more contents in operation 901.

In operation 902, the electronic device 100 may detect a command for sharing one or more contents with another electronic device, e.g., by detecting user selection of a content sharing icon.

In operation 903, the electronic device may display at least one contact list including information on another electronic device, which can share one or more contents. For example, the electronic device 100 may display the contact list on the display in response to the command for sharing contents. Here, the electronic device may execute the content sharing function or search for another activated electronic device in response to the command for sharing the contents. The electronic device may display the contact list updated based on search information on other electronic devices.

In operation 904, the electronic device 100 may detect a user selection of at least one contact from the displayed contact list.

In operation 905, the electronic device may display at least one service list corresponding to the selected contact on the display. For example, the electronic device may display the service list updated based on whether another electronic device, which can share one or more contents, is found and a preset priority.

In operation 906, the electronic device may select one application or service from the service list based on input information detected through the I/O interface.

In operation 907, the electronic device may transmit one or more contents selected in operation 901 to one or more other electronic devices corresponding to one or more contact selected in operation 904 by using the selected application or service.

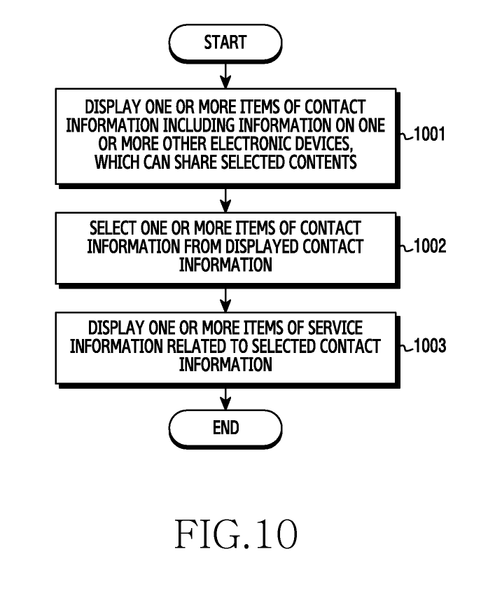

FIG. 10 is a flowchart illustrating a process in which an electronic device displays a contact list according to various embodiments. In operation 1001, the electronic device 100 may display at least one contact list including information on one or more other electronic devices, which can share one or more contents, on the display.

In operation 1002, the electronic device 100 may detect a user selection of at least one contact from the contact list displayed on the display.

In operation 1003, the electronic device 100 may display at least one service list corresponding to the selected contact on the display.

According to various embodiments of the present disclosure, a method of operating an electronic device (e.g. 100) may include: detecting a user selection of one or more contents; displaying contacts which can share the selected contents via other electronic devices; detecting a user selection of one or more of the displayed contacts; and displaying information of at least one application or service, corresponding to the selected one or more contacts, through which the selected contents can be shared According to various embodiments, the method may further include searching for one or more other electronic devices, which can share the selected contents, in response to the selection of the one or more contents.

According to various embodiments, the displaying of the one or more pieces of contact information may include displaying the one or more pieces of contact information based on at least one of search information on other electronic devices, which can share the selected contents, and a preset priority.

According to various embodiments, the priority may be determined based on at least one of a transmission history, a transmission frequency, a transmission speed, a charging policy, preset user favorites, a counterpart's location, a schedule, and application preference.

According to various embodiments, the service information may include one or more pieces of application information based on the selected contact information.

According to various embodiments, the displaying of the one or more pieces of service information may include displaying the one or more pieces of service information based on a priority corresponding to the one or more pieces of selected contact information.

According to various embodiments, the priority may be determined based on at least one of configuration information of a service provider, configuration information of a manufacturer, contact information, application preference, user preference, a use time point, a distance from a target to share content, a transmission history, and a charging policy.

According to various embodiments, the displaying of the one or more pieces of service information may include displaying the one or more pieces of service information corresponding to the selected contents and the one or more pieces of selected contact information.

According to various embodiments, the method may further include: selecting one piece of service information from the one or more pieces of service information; and transmitting the one or more contents to other electronic devices corresponding to the one or more pieces of selected contact information through the selected service information.

According to various embodiments, the method may further include transmitting the one or more contents to one or more other electronic devices located within a predetermined distance.

In various embodiments, the one or more contents may comprise a first contents of a first type and a second contents of a second type. The method may further include automatically selecting a first application or service to transmit the first contents to the one or more selected contacts in accordance with the first type, and automatically selecting a second application or service to transmit the second contents to the one or more selected contacts in accordance with the second type. As but one example, the first type of contents may be a still image and the second type of contents may be a video. Alternatively, instead of the automatically selection, the method may include receiving a user selection of a first application or service to transmit the first contents to the one or more selected contacts, and receiving a user selection of a second application or service to concurrently transmit the second contents to the one or more selected contacts.

An electronic device and a method according to various embodiments can improve user convenience for the electronic device sharing contents by selecting a service or application suitable for content sharing based on information on a target to share contents.

An electronic device and a method according to various embodiments can improve usability of content sharing by automatically selecting a service or application for sharing contents without selection by the user.

The above-described methods according to the present disclosure can be implemented with the use of in hardware, firmware or as software or computer code that can be stored in a non-transitory recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered using such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. No claim element herein is to be construed under the provisions of 35 U.S.C. 112, sixth paragraph, unless the element is expressly recited using the phrase “means for.”

Embodiments of the present disclosure provided in the present specification and drawings are merely certain examples to readily describe the technology associated with embodiments of the present disclosure and to help understanding of the embodiments of the present disclosure, but may not limit the scope of the embodiments of the present disclosure. Therefore, in addition to the embodiments disclosed herein, the scope of the various embodiments of the present disclosure should be construed to include all modifications or modified forms drawn based on the technical idea of the various embodiments of the present disclosure.

What is claimed is:

1. A method in an electronic device, the method comprising:
detecting a selection of one or more contents;
displaying contacts which can share the selected contents via other electronic devices;
detecting a selection of one or more of the displayed contacts; and
displaying information of at least one application or service, corresponding to the selected one or more contacts, through which the selected contents can be shared.

2. The method of claim 1, further comprising searching for one or more other electronic devices associated with contacts which can share the selected contents, in response to the selection of the one or more contents.

3. The method of claim 1, wherein the displaying of the contacts is based on at least one of: i) search information on other electronic devices associated with contacts which can share the selected contents, and ii) a preset priority.

4. The method of claim 3, wherein the priority is determined based on at least one of a transmission history, a transmission frequency, a transmission speed, a charging policy, preset user favorites, a counterpart's location, a schedule, and application preference.

5. The method of claim 1, wherein the information of at least one application or service includes information of at least one application corresponding to the selected one or more contacts.

6. The method of claim 1, wherein the displaying of the information of at least one application or service comprises displaying information on at least one service based on a priority corresponding to the one or more selected contacts.

7. The method of claim 6, wherein the priority is determined based on at least one of configuration information of a service provider, configuration information of a manufacturer, contact information, application preference, user preference, a use time point, a distance from a target to share content, a transmission history, and a charging policy.

8. The method of claim 1, wherein the displaying of the information of a at least one application or service comprises displaying information of at least one service corresponding to the selected contents and the one or more selected contacts.

9. The method of claim 1, further comprising:
detecting a selection of an application or service from the displayed information; and
transmitting the one or more contents to other electronic devices corresponding to the selected one or more contacts through the selected application or service.

10. The method of claim 1, further comprising transmitting the one or more contents to one or more other electronic devices associated with at least one contact located within a predetermined distance.

11. An electronic device comprising:
an input/output (I/O) interface;
a communication module configured to transmit/receive contents to/from one or more other electronic devices associated with respective contacts;
a display; and
a processor configured to:
detect a selection via the I/O interface of one or more contents;
control the display to display contacts which can share the selected contents via other electronic devices;
detect a selection via the I/O interface of one or more of the displayed contacts; and
control the display to display information of at least one application or service, corresponding to the selected one or more contacts, through which the selected contents can be shared.

12. The electronic device of claim 11, wherein the communication module is configured to search for one or more other electronic devices associated with contacts, which can share the selected contents, in response to the selection of the one or more contents.

13. The electronic device of claim 11, wherein the processor is configured to control the display to display the contacts based on at least one of: i) search information on other electronic devices associated with contacts, which can share the selected contents, through the communication module; and ii) a preset priority.

14. The electronic device of claim 13, wherein the priority is determined based on at least one of a transmission history, a transmission frequency, a transmission speed, a charging policy, preset user favorites, a counterpart's location, a schedule, and application preference.

15. The electronic device of claim 11, wherein the information of at least one application or service includes information of at least one application corresponding to the selected one or more contacts.

16. The electronic device of claim 11, wherein the processor is configured to control the display to display information on at least one service based on a priority corresponding to the one or more selected contacts.

17. The electronic device of claim 16, wherein the priority is determined based on at least one of configuration information of a service provider, configuration information of a manufacturer, contact information, application preference, user preference, a use time point, a distance from a target to share content, a transmission history, and a charging policy.

18. The electronic device of claim 11, wherein the processor is configured to control the display to display information of at least one service corresponding to the selected contents and the one or more selected contacts.

19. The electronic device of claim 11, wherein the processor is configured to detect a selection of an application or service from the displayed information, and control the communication module to transmit the one or more contents to other electronic devices corresponding to the selected one or more contacts through the selected application or service.

20. The electronic device of claim 11, the processor is configured to control the communication module to transmit the one or more contents to one or more other electronic devices associated with at least one contact located within a predetermined distance.
